(19) United States
(12) Patent Application Publication
(10) Pub. No.: US 2024/0427757 A1
(43) Pub. Date: Dec. 26, 2024

(54) DATA VERIFICATION APPARATUS, CLIENT APPLICATION, BLOCKCHAIN SYSTEM, DATA VERIFICATION METHOD, AND NON-TRANSITORY COMPUTER READABLE MEDIUM

(71) Applicant: Mitsubishi Electric Corporation, Tokyo (JP)

(72) Inventors: Nako TSUDA, Tokyo (JP); Hiroshi YOKOCHI, Tokyo (JP); Mitsuhiro MATSUMOTO, Tokyo (JP)

(73) Assignee: Mitsubishi Electric Corporation, Tokyo (JP)

(21) Appl. No.: 18/830,232

(22) Filed: Sep. 10, 2024

Related U.S. Application Data
(63) Continuation of application No. PCT/JP2022/015699, filed on Mar. 29, 2022.

(51) Int. Cl. G06F 16/23

(52) U.S. Cl. CPC G06F 16/2365; G06F 16/2379

(57) ABSTRACT

A data verification apparatus (1) that verifies electronic data to be registered in a distributed ledger (5) includes a data verification unit (8), a data control unit (7), and a data registration unit (10). The data verification unit (8) determines whether or not registration data to be registered in the distributed ledger (5) complies with a verification rule which is a rule for verifying the electronic data to be registered in the distributed ledger (5). The data control unit (7) determines whether or not the data verification unit (8) has been generated in a blockchain. When it is determined that the data verification unit (8) has been generated in the blockchain and when it is determined that the registration data complies with the verification rule, the data registration unit (10) registers the registration data in the distributed ledger (5).

### CROSS REFERENCE TO RELATED APPLICATIONS

This application is a Continuation of PCT International Application No. PCT/JP2022/015699, filed on Mar. 29, 2022, all of which is hereby expressly incorporated by reference into the present application.

### TECHNICAL FIELD

The present disclosure relates to a data verification apparatus, a client application, a blockchain system, a data verification method, and a data verification program.

### BACKGROUND ART

With Blockchain (BC) technology, the reliability of information exchanged in a system is secured through a process of consensus formation in a distributed network, and fraud such as falsification can be prevented throughout the system. Then, the use of the blockchain technology is being considered as a purpose of the security for traceability. In the system that uses the BC technology, registered data is shared by participants in a BC network, and is determined to be valid data. Therefore, before data is registered in the system, it is required to verify whether or not the data is input data based on a rule. Then, in order to increase the reliability of a data verification Smart Contract (SC), there is a technology (for example, Non-Patent Literature 1) that secures the validity of a verification result by automatically generating the data verification SC in the BC, and verifying the data, using the generated data verification SC. The data verification SC is an SC for verifying data. The SC is a program to be executed in the BC, using a transaction, external information, or the like as a trigger, in accordance with a predetermined rule. Verification of data, registration of data, reference of data, and the like can be implemented by the SC.

### CITATION LIST

### Patent Literature

Non-Patent Literature 1: Ethereum, “Contracts-Solidity 0.5.4 document”, [online], Jul. 12, 2019, Solidity, [searched in Nov. 9, 2021] the Internet <URL: https://solidity-jp.readthedocs.io/ja/latest/contracts.html>

### SUMMARY OF INVENTION

### Technical Problem

In a technology disclosed in Non-Patent Literature 1, a data verification SC is generated in a BC, and a data registration SC registers in a distributed ledger, registration data verified by the data verification SC. The data registration SC is an SC for registering data. However, this technology has a problem in that it is not secured that the data verification SC used when the registration data is verified is the data verification SC generated in the BC.

The present disclosure aims to secure that a data verification SC used when registration data is verified is a data verification SC generated in a BC, in a technology to verify the registration data required to be registered in a distributed ledger, using the data verification SC generated in the BC.

### Solution to Problem

A data verification apparatus according to the present disclosure that verifies electronic data to be registered in a distributed ledger stored in a server that constitutes a blockchain, the data verification apparatus includes:
a data verification unit to execute a data verification process to determine whether or not registration data which is electronic data required to be registered in the distributed ledger complies with a verification rule which is a rule for verifying the electronic data to be registered in the distributed ledger;
a data control unit to determine whether or not a program corresponding to the data verification process has been generated in the blockchain; and
a data registration unit to execute a verification registration process when it is determined that the program corresponding to the data verification process has been generated in the blockchain, wherein
the verification registration process is a process to register the registration data in the distributed ledger when it is determined through the data verification process that the registration data complies with the verification rule.

### Advantageous Effects of Invention

According to the present disclosure, a data control unit determines whether or not a program corresponding to a data verification process has been generated in a BC. Further, when it is determined that the program corresponding to the data verification process has been generated in the BC, a data registration unit executes a verification registration process. Here, the program corresponding to the data verification process is equivalent to a data verification SC. Thus, according to the present disclosure, in a technology to verify registration data required to be registered in a distributed ledger, using the data verification SC generated in the BC, it is possible to secure that the data verification SC used when the registration data is verified is the data verification SC generated in the BC.

### BRIEF DESCRIPTION OF DRAWINGS

FIG. 1 is a diagram illustrating a configuration example of a BC system 90 according to Embodiment 1.

FIG. 2 is a diagram illustrating a hardware configuration example of the BC system 90 according to Embodiment 1.

FIG. 3 is a flowchart illustrating a deploy process according to Embodiment 1.

FIG. 4 is a flowchart illustrating a data registration process according to Embodiment 1.

FIG. 5 is a flowchart illustrating a data reference process according to Embodiment 1.

FIG. 6 is a diagram illustrating a hardware configuration example of a data verification apparatus 1 according to a modification of Embodiment 1.

FIG. 7 is a diagram illustrating a configuration example of the BC system 90 according to Embodiment 2.

FIG. 8 is a flowchart illustrating the deploy process according to Embodiment 2.

FIG. 9 is a flowchart illustrating the data registration process according to Embodiment 2.

FIG. 10 is a flowchart illustrating the data reference process according to Embodiment 2.

FIG. 11 is a diagram illustrating a configuration example of the BC system 90 according to Embodiment 3.

FIG. 12 is a flowchart illustrating the data registration process according to Embodiment 3.

FIG. 13 is a flowchart illustrating the data reference process according to Embodiment 3.

FIG. 14 is a diagram illustrating a configuration example of the BC system 90 according to Embodiment 4.

FIG. 15 is a flowchart illustrating the data registration process according to Embodiment 4.

FIG. 16 is a flowchart illustrating the data registration process according to Embodiment 4.

FIG. 17 is a flowchart illustrating the data reference process according to Embodiment 4.

FIG. 18 is a flowchart illustrating the data reference process according to Embodiment 4.

### DESCRIPTION OF EMBODIMENTS

In the description and drawings of embodiments, the same elements and corresponding elements are denoted by the same reference sign. The description of elements denoted by the same reference sign will be suitably omitted or simplified. Arrows in the drawings mainly indicate flows of data or flows of processing. Further, “unit” may be suitably interpreted as “circuit”, “step”, “procedure”, “process”, “circuitry”, or “smart contract”.

### Embodiment 1

The present embodiment will be described below in detail with reference to the drawings.

### *** Description of Configuration ***

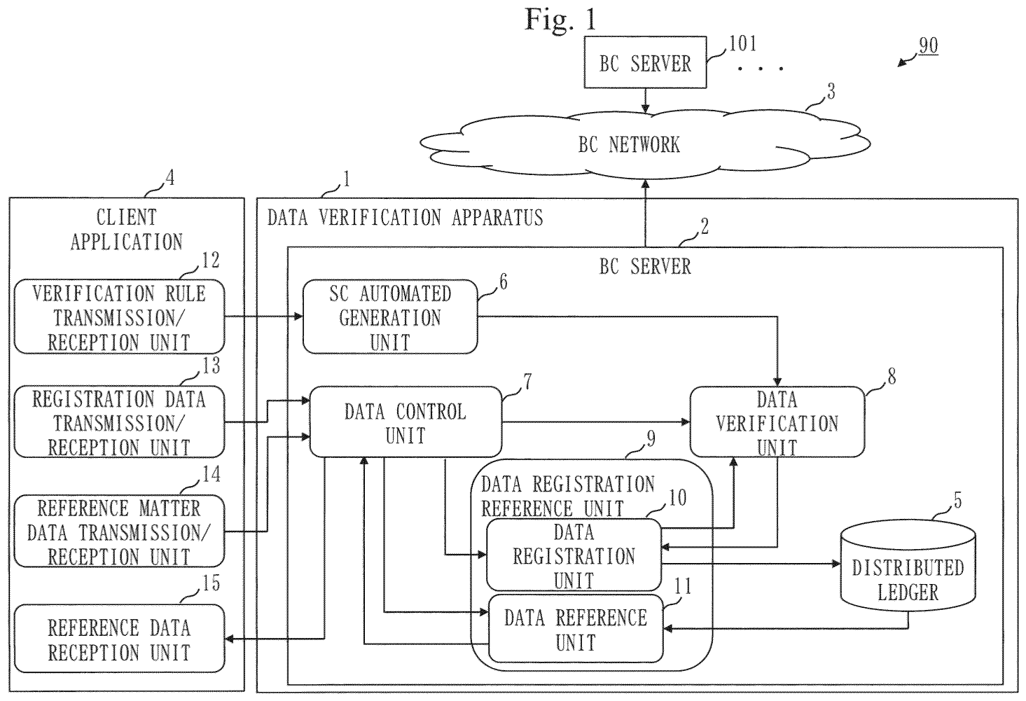

FIG. 1 illustrates a system configuration example of a Blockchain (BC) system 90 according to the present embodiment. The BC system 90 is a system that implements a blockchain. As illustrated in FIG. 1, the BC system 90 includes a data verification apparatus 1, a BC network 3, a client application 4, and a BC server 101.

The data verification apparatus 1 is an apparatus that includes a BC server 2, is an apparatus that verifies electronic data to be registered in a distributed ledger 5, and is referred to as a data registration reference verification apparatus.

The BC server 2 is a server that constitutes a BC, and includes a Smart Contract (SC) automated generation unit 6, a data control unit 7, a data verification unit 8, a data registration reference unit 9, and the distributed ledger 5.

The SC automated generation unit 6 receives from the client application 4, data indicating a verification rule, generates the data verification unit 8 based on the received data, and deploys the generated data verification unit 8. The verification rule is a rule for verifying electronic data to be registered in the distributed ledger 5, and is a rule that needs to be complied by the electronic data to be registered in the distributed ledger 5.

The data control unit 7 receives data from the client application 4, and verifies each of a data registration unit 10, a data reference unit 11, and the data verification unit 8, based on the received data. A process to verify the data verification unit 8 is a process to determine whether or not the data verification unit 8 has been generated by the SC automated generation unit 6, and is a process to determine whether or not a program corresponding to a data verification process has been generated in the BC. The program corresponding to the data verification process is a program that implements the data verification unit 8. The data verification process is a process to determine whether or not registration data complies with the verification rule.

Further, the data control unit 7 transmits the registration data to the data registration unit 10, transmits reference matter data to the data reference unit 11, and receives reference data from the data reference unit 11. The registration data is electronic data that is required to be registered in the distributed ledger 5, and is electronic data that may be registered in the distributed ledger 5. The reference matter data is electronic data indicating a matter to be referred to in the distributed ledger 5, and is electronic data indicating an instruction to refer to electronic data registered in the distributed ledger 5. The reference data is electronic data referred to by the data reference unit 11, is electronic data corresponding to the reference matter data, and is electronic data registered in the distributed ledger 5.

The data control unit 7 executes a registration instruction process. When only electronic data indicated through the registration instruction process is registered in the distributed ledger and when electronic data is registered in the distributed ledger 5 through a verification registration process, the data control unit 7 determines that the reference data has been registered in the distributed ledger 5 through the verification registration process. The registration instruction process is a process to instruct electronic data to be registered in the distributed ledger 5. The verification registration process verifies the registration data, using the data verification unit 8, and is a process to register the registration data in the distributed ledger 5, based on verification result data corresponding to the registration data. That is, the verification registration process is a process to register the registration data in the distributed ledger 5 when it is determined through the data verification process that the registration data complies with the verification rule. The verification result data is data indicating a verification result by the data verification unit 8. The verification result data corresponding to the registration data is data indicating a result of verifying the registration data by the data verification unit 8.

When only electronic data indicated through the registration instruction process is registered in the distributed ledger 5, when electronic data is registered in the distributed ledger 5 through the verification registration process, and when a transmission source address of the reference data is an address corresponding to a program corresponding to the verification registration process, the data control unit 7 determines that the reference data has been registered in the distributed ledger 5 through the verification registration process. The program corresponding to the verification registration process is a program that implements the data registration unit 10. The address corresponding to the program corresponding to the verification registration process is an address of data indicating the data registration unit 10.

The data verification unit 8 receives the registration data from the data registration unit 10, and executes the data verification process on the received registration data.

The data registration reference unit 9 includes the data registration unit 10 and the data reference unit 11.

The data registration unit 10 receives the registration data from the data control unit 7, transmits the registration data to the data verification unit 8 in order to verify the received registration data, receives from the data verification unit 8, data indicating a result of verifying the registration data, and registers in the distributed ledger 5, the registration data verified by the data verification unit 8. When it is determined that the program corresponding to the data verification process has been generated in the BC, the data registration unit 10 executes the verification registration process.

The data reference unit 11 receives the reference matter data from the data control unit 7, obtains the reference data from the distributed ledger 5 based on the received reference matter data, and transmits the obtained reference data to the data control unit 7. At this time, when it is determined that the program corresponding to the data verification process has been generated in the BC and when it is determined that the reference data has been registered in the distributed ledger 5 through the verification registration process, the data reference unit 11 executes a data reference process. The data reference process is a process to refer to electronic data registered in the distributed ledger 5 based on the reference matter data. When the data verification unit 8 has been generated in the BC and when the data registration unit 10 executes the verification registration process and a limited registration process, it is determined that the reference data has been registered in the distributed ledger 5 through the verification registration process. The limited registration process is a process to register the registration data in the distributed ledger 5 only when the registration data is data transmitted from the data control unit 7. When the data registration unit 10 executes the limited registration process, only electronic data indicated through the registration instruction process is registered in the distributed ledger 5.

The distributed ledger 5 is stored in the BC server 2 and data is registered by the data registration unit 10. The data registered in the distributed ledger 5 is referred to by the data reference unit 11.

Each of the SC automated generation unit 6, the data control unit 7, the data verification unit 8, the data registration reference unit 9, the data registration unit 10, and the data reference unit 11 is an SC. The SC is a program that is executed in the BC system 90, using a transaction, external information, or the like, as a trigger, in accordance with a predetermined rule. The program typically refers to a computer executable file.

The BC network 3 is a network that connects to a BC server such as the BC server 2, the BC server 101, or the like. The BC network 3 is connected to a single BC server or a plurality of BC servers.

The BC server 101 may not have the same function as that of the BC server 2. The number of BC servers 101 may be plural.

The client application 4 is an application that includes a verification rule transmission/reception unit 12, a registration data transmission/reception unit 13, a reference matter data transmission/reception unit 14, and a reference data reception unit 15. The client application 4 is an apparatus that communicates with a server that constitutes a BC, and is an apparatus that executes an application program. Data transmitted to the data verification apparatus 1 by each unit included in the client application 4 may be data received by the client application 4 from a user, and may be data input by the user to the client application 4. The user is a user of the BC system 90. The user is not limited to a human being, and may be a computer or the like.

The verification rule transmission/reception unit 12 transmits to the SC automated generation unit 6, the data indicating the verification rule.

The registration data transmission/reception unit 13 specifies the data registration reference unit 9 to be used, and transmits the registration data to the data control unit 7 corresponding to the specified data registration reference unit 9. The registration data transmission/reception unit 13 may specify the data registration unit 10 to be used.

The reference matter data transmission/reception unit 14 specifies the data registration reference unit 9 to be used, and transmits the reference matter data to the data control unit 7 corresponding to the specified data registration reference unit 9. The reference matter data transmission/reception unit 14 may specify the data reference unit 11 to be used.

The reference data reception unit 15 receives the reference data from the data control unit 7.

The BC system 90 may not include the client application 4, and the same function as a function provided by the client application 4 may be implemented by the user accessing the BC server 2 and controlling the BC server 2.

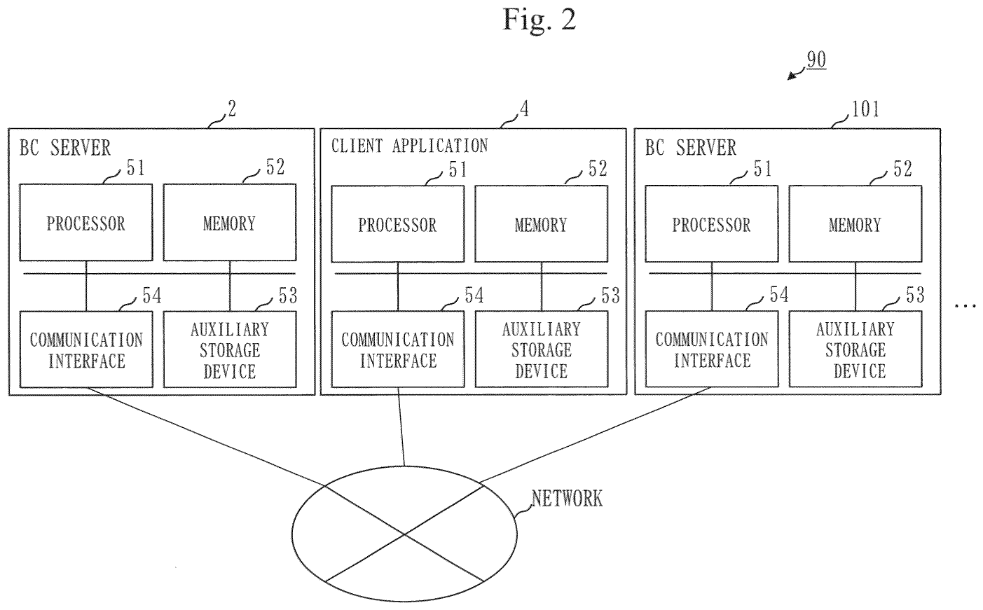

FIG. 2 illustrates a hardware configuration example of the BC system 90.

FIG. 2 illustrates a specific example in a case where each of the BC server 2, the client application 4, and the BC server 101 operates in an independent apparatus. Each apparatus includes pieces of hardware such as a processor 51, a memory 52, an auxiliary storage device 53, and a communication interface 54. The pieces of hardware included in each apparatus are appropriately connected via a bus.

The bus is a signal path that electrically connects between the pieces of hardware, and exchanges data. A communication path connects between apparatuses and between devices. The communication path may be a wired communication path or may be a wireless communication path.

The processor 51 reads a program stored in the auxiliary storage device 53, deploys the read program to the memory 52, and executes the deployed program. The processor 51 is connected to other pieces of hardware via a bus, and controls each piece of hardware. The processor 51 may be an Integrated Circuit (IC) that performs processing, and may be, as a specific example, a microprocessor or a Digital Signal Processor (DSP). Each apparatus may include a plurality of processors.

The program read by the processor 51 from the auxiliary storage device 53 is deployed to the memory 52. The memory 52 is referred to as a main memory, and is, as a specific example, a volatile semiconductor memory or the like such as a Random Access Memory (RAM).

The auxiliary storage device 53 stores software, firmware, or a program in which combination of software and firmware are written, an Operating System (OS), and the like. Further, the auxiliary storage device 53 stores various information and the like. Data and information may have the same meaning. The auxiliary storage device 53 is, as a specific example, a non-volatile semiconductor memory such as a Read Only Memory (ROM), a flash memory, an Erasable Programmable Read Only Memory (EPROM), an Electrically Erasable Programmable Read Only Memory (EEPROM), or a Hard Disk Drive (HDD), a portable recording medium such as a magnetic disk, a flexible disk, an optical disc, a compact disc, a mini disc, or a Digital Versatile Disc (DVD), or the like. Each apparatus may appropriately use an external storage device.

The communication interface 54 is a connection unit that exchanges information between the pieces of hardware.

Each function of the BC system 90 can be implemented by hardware, software, firmware, or a combination thereof. A part of each function of the BC system 90 may be implemented by dedicated hardware, and the remaining may be implemented by software or firmware. Software, hardware, or a combination of software and hardware may be written as a program.

In an apparatus that implements the BC server 2, the processor 51 is in charge of controlling each unit included in the BC server 2, and a program that is read by the processor 51 from the auxiliary storage device 53 and that implements each unit included in the BC server 2 is deployed to the memory 52. In the apparatus that implements the BC server 2, the auxiliary storage device 53 stores the program that implements a function of each unit included in the BC server 2 and information registered in the distributed ledger 5. In the apparatus that implements the BC server 2, each of the SC automated generation unit 6 and the data control unit 7 is connected to the client application 4, the BC server 101, and the like, using the communication interface 54.

In an apparatus that implements the client application 4, the processor 51 is in charge of controlling each unit included in the client application 4, and a program that is read by the processor 51 from the auxiliary storage device 53 and that implements a function of each unit included in the client application 4 is deployed to the memory 52. In the apparatus that implements the client application 4, the auxiliary storage device 53 stores the program that implements the function of each unit included in the client application 4. In the apparatus that impalements the client application 4, each unit included in the client application 4 is connected to the BC server 2 and the like, using the communication interface 54.

Each apparatus is connected via a network. Although FIG. 2 illustrates a specific example in which each apparatus is connected to one network, the network may be divided into a plurality of parts as long as each of communication between the BC server 2 and the client application 4 and communication between the BC server 2 and the BC server 101 is possible. Further, at least a part of the BC server 2, the client application 4, and the BC server 101 may be implemented by one apparatus. Further, each apparatus is not limited to an apparatus that has a physical substance, and may be an apparatus virtualized, using virtualization technology.

Any program described in the present specification may be recorded in a computer readable non-volatile recording medium. The non-volatile recording medium is, as a specific example, an optical disc or a flash memory. Any program described in the present specification may be provided as a program product.

### *** Description of Operation ***

An operation procedure of the data verification apparatus 1 is equivalent to a data verification method. Further, a program that implements operation of the data verification apparatus 1 is equivalent to a data verification program.

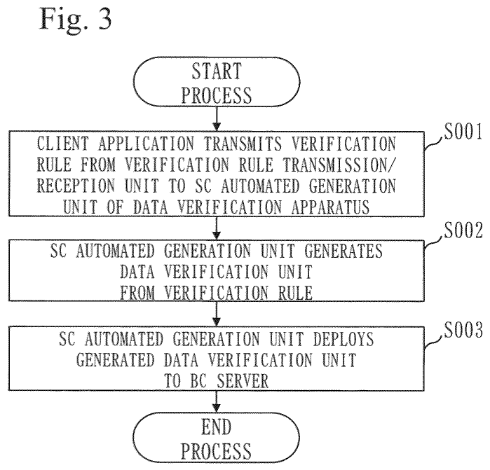

FIG. 3 is a flowchart illustrating an example of a deploy process. The deploy process is a process to generate the data verification unit 8 and to deploy the generated data verification unit 8 to the BC server 2, and is referred to as a data verification unit generation and deploy process.

### (Step S001)

The verification rule transmission/reception unit 12 transmits to the SC automated generation unit 6, data indicating the verification rule input by the user.

### (Step S002)

The SC automated generation unit 6 receives from the verification rule transmission/reception unit 12, the data indicating the verification rule, and generates the data verification unit 8 based on the verification rule indicated in the received data. As a specific example, the data verification unit 8 is generated by embedding the verification rule indicated in the received data, into a template which is an original template of an SC held in advance by the SC automated generation unit 6.

### (Step S003)

The SC automated generation unit 6 deploys the generated data verification unit 8 to the BC server 2.

Through the above deploy process, the data verification unit 8 is usable in a BC server connected to the BC network 3. The data verification unit 8 may be usable only in some of BC servers among the BC servers connected to the BC network 3.

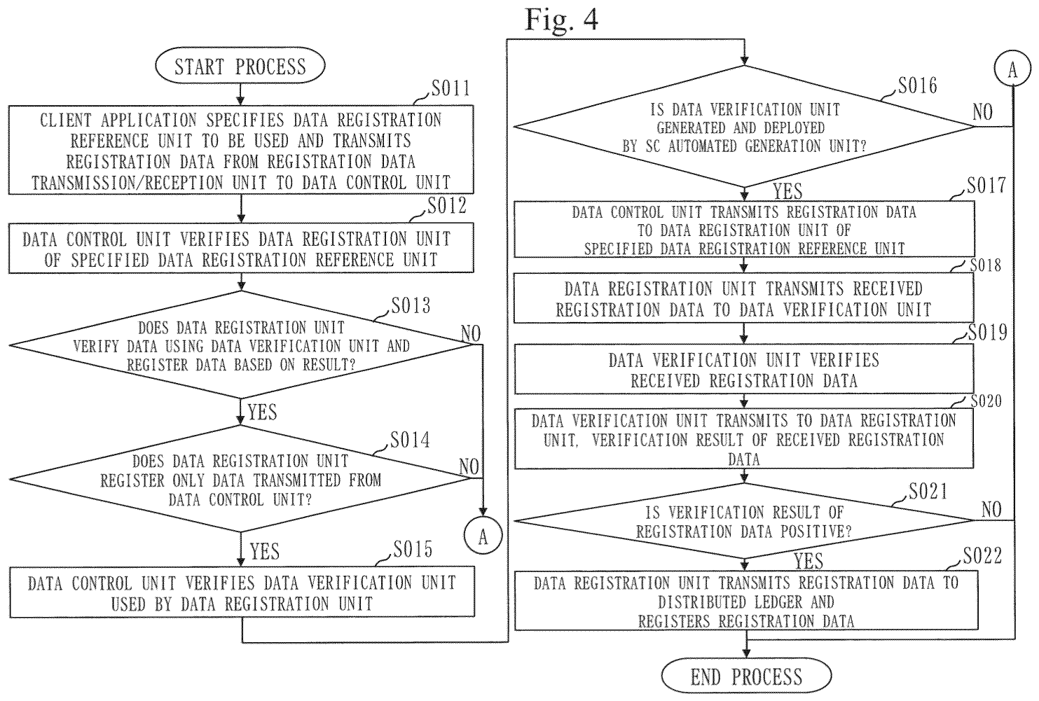

FIG. 4 is a flowchart illustrating an example of a data registration process. The data registration process will be described with reference to FIG. 4.

### (Step S011)

The registration data transmission/reception unit 13 specifies the data registration reference unit 9 to be used, and transmits to the data control unit 7 corresponding to the specified data registration reference unit 9, the registration data input by the user.

### (Step S012)

The data control unit 7 verifies the data registration unit 10 included in the specified data registration reference unit 9. Matters verified by the data control unit 7 will be described in steps S013 and S014.

### (Step S013)

The data control unit 7 determines whether or not the data registration unit 10 executes the verification registration process.

Specifically, the data control unit 7 checks whether or not each of the following three points is satisfied regarding a configuration of the program that implements the data registration unit 10. When all of the three points are satisfied, the data control unit 7 determines that the data registration unit 10 executes the verification registration process.

The first point is that a configuration of the data registration unit 10 is a configuration to transmit to the data verification unit 8, the registration data received by data registration unit 10.

The second point is that the configuration of the data registration unit 10 is a configuration to receive from the data verification unit 8, the verification result data corresponding to the registration data.

The third point is that the configuration of the data registration unit 10 is a configuration to determine whether or not the registration data is registered in the distributed ledger 5, based on the verification result data which is received from the data verification unit 8 and which corresponds to the registration data.

When the data registration unit 10 executes the verification registration process, the data verification apparatus 1 transitions to step S014. When the data registration unit 10 does not verify the registration data, using the data verification unit 8, or when the data registration unit 10 does not register the registration data in the distributed ledger 5, based on the verification result data corresponding to the registration data, the data verification apparatus 1 skips all of processes onwards and ends the data registration process.

### (Step S014)

The data control unit 7 determines whether or not the data registration unit 10 executes the limited registration process.

Specifically, the data control unit 7 checks whether or not each of the following two points is satisfied regarding the configuration of the program that implements the data registration unit 10. When all of the two points are satisfied, the data control unit 7 determines that the data registration unit 10 executes the limited registration process.

The first point is that the configuration of the data registration unit 10 is a configuration to check whether or not the registration data received by the data registration unit 10 is data transmitted from the data control unit 7.

The second point is that the configuration of the data registration unit 10 is a configuration to end processing of a program without registering in the distributed ledger 5, the registration data that is determined not to have been transmitted from the data control unit 7.

When the data registration unit 10 executes the limited registration process, the data verification apparatus 1 transitions to step S015. Otherwise, the data verification apparatus 1 skips all of processes onwards and ends the data registration process.

### (Step S015)

The data control unit 7 verifies the data verification unit 8 used by the data registration unit 10. In step S016, matters verified by the data control unit 7 will be described.

### (Step S016)

The data control unit 7 determines whether or not the data verification unit 8 is an authenticity data verification unit. The authenticity data verification unit according to the present embodiment is a data verification unit that has been generated by the SC automated generation unit 6 and that has been deployed by the SC automated generation unit 6. Whether or not the data verification unit 8 is the authenticity data verification unit is determined by whether or not a transmission source address of the data verification unit 8 is an address indicating the SC automated generation unit 6.

When the data verification unit 8 is the authenticity data verification unit, the data verification apparatus 1 transitions to step S017. Otherwise, the data verification apparatus 1 skips all of processes onwards and ends the data registration process.

### (Step S017)

The data control unit 7 transmits the registration data to the data registration unit 10 included in the specified data registration reference unit 9.

### (Step S018)

The data registration unit 10 receives the registration data, and transmits the received registration data to the data verification unit 8.

### (Step S019)

The data verification unit 8 receives the registration data, and verifies the received registration data. Specifically, the data verification unit 8 verifies whether or not the received registration data complies with the verification rule input when the data verification unit 8 has been generated.

### (Step S020)

The data verification unit 8 transmits to the data registration unit 10, the verification result data indicating a result of verifying the received registration data. When receiving the registration data that complies with the verification rule, the data verification unit 8 transmits to the data registration unit 10, the verification result data indicating that the verification result is positive. Otherwise, the data verification unit 8 transmits to the data registration unit 10, the verification result data indicating that the verification result is negative.

### (Step S021)

The data registration unit 10 receives the verification restful data, and checks the received verification result data. When the verification result indicated in the received verification result data is positive, the data verification apparatus 1 transitions to step S022. Otherwise, the data verification apparatus 1 skips all of processes onwards and ends the data registration process.

### (Step S022)

The data registration unit 10 transmits the registration data to the distributed ledger 5, and registers the registration data in the distributed ledger 5.

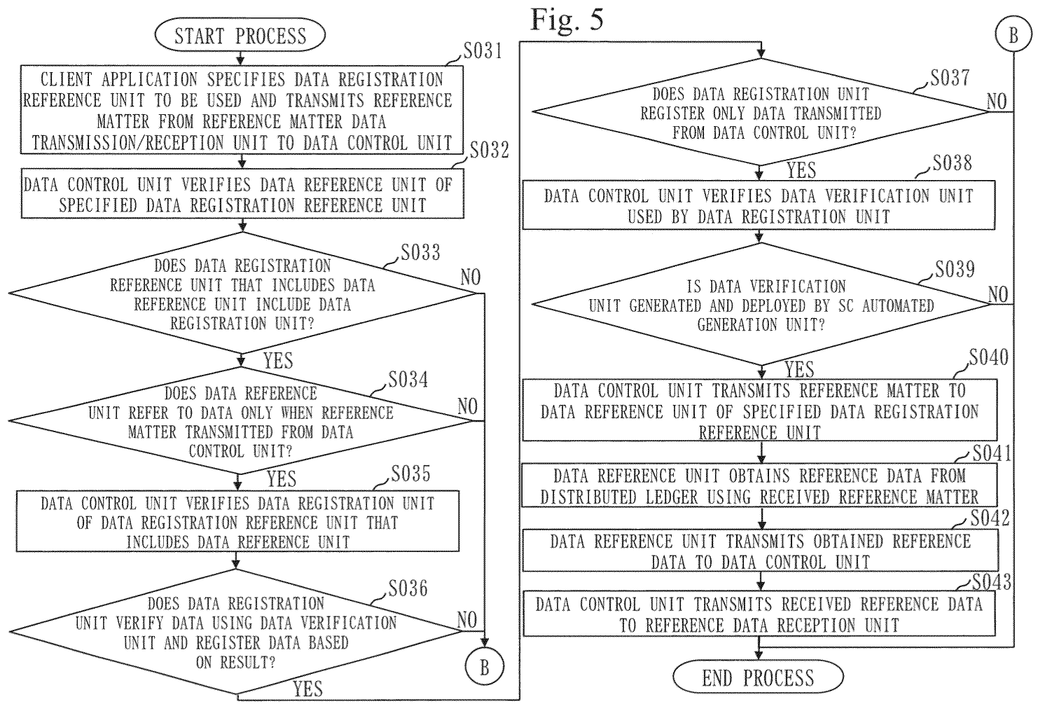

FIG. 5 is a flowchart illustrating an example of the data reference process. The data reference process will be described with reference to FIG. 5.

### (Step S031)

The reference matter data transmission/reception unit 14 specifies the data registration reference unit 9 to be used, and transmits to the data control unit 7 corresponding to the specified data registration reference unit 9, the reference matter data input by the user.

### (Step S032)

The data control unit 7 verifies the data reference unit 11 included in the specified data registration reference unit 9. Matters verified by the data control unit 7 will be described in steps S033 and S034.

### (Step S033)

The data control unit 7 checks whether or not the data registration reference unit 9 that includes the data reference unit 11 includes the data registration unit 10. Specifically, the data control unit 7 checks whether or not a program that implements the data registration reference unit 9 includes a part that implements the data registration unit 10 and a part that implements the data reference unit 11. When the program that implements the data registration reference unit 9 includes the part that implements the data registration unit 10 and the part that implements the data reference unit 11, the data control unit 7 determines that the data registration reference unit 9 that includes the data reference unit 11 includes the data registration unit 10.

When the data registration reference unit 9 that includes the data reference unit 11 includes the data registration unit 10, the data verification apparatus 1 transitions to step S034. Otherwise, the data verification apparatus 1 skips all of processes onwards and ends the data reference process.

### (Step S034)

The data control unit 7 determines whether or not the data reference unit 11 executes a limited reference process. The limited reference process is a process to refer to data registered in the distributed ledger 5 only when the received reference matter data is data transmitted from the data control unit 7. Specifically, the data control unit 7 checks whether or not each of the following two points is satisfied regarding a configuration of the program that implements the data reference unit 11. When all of the two points are satisfied, the data control unit 7 determines that the data reference unit 11 executes the limited reference process.

The first point is that a configuration of the data reference unit 11 is a configuration to check whether or not the reference matter data received by the data reference unit 11 is transmitted from the data control unit 7 when the data reference unit 11 has received the reference matter data.

The second point is that the configuration of the data reference unit 11 is a configuration to end processing by the data reference unit 11 without referring to data registered in the distributed ledger 5 when the reference matter data received by the data reference unit 11 is not data transmitted from the data control unit 7.

When the data reference unit 11 executes the limited reference process, the data verification apparatus 1 transitions to step S035. Otherwise, the data verification apparatus 1 skips all of processes onwards and ends the data reference process.

### (Step S035)

The data control unit 7 verifies the data registration unit 10 included in the data registration reference unit 9 included in the data reference unit 11. Matters verified by the data control unit 7 will be described in steps S036 and S037.

### (Step S036)

The present step is the same as step S013.

When the data registration unit 10 executes the verification registration process, the data verification apparatus 1 transitions to step S037. Otherwise, the data verification apparatus 1 skips all of processes onwards and ends the data reference process.

### (Step S037)

The present step is the same as step S014.

When the data registration unit 10 executes the limited registration process, the data verification apparatus 1 transitions to step S038. Otherwise, the data verification apparatus 1 skips all of processes onwards and ends the data reference process.

### (Step S038)

The data control unit 7 verifies the data verification unit 8 used by the data registration unit 10. Matters verified by the data control unit 7 will be described in step S039.

### (Step S039)

The present step is the same as step S016.

When the data verification unit 8 is the authenticity data verification unit, the data verification apparatus 1 transitions to step S040. Otherwise, the data verification apparatus 1 skips all of processes onwards and ends the data reference process.

### (Step S040)

The data control unit 7 transmits the reference matter data to the data reference unit 11 included in the specified data registration reference unit 9.

### (Step S041)

The data reference unit 11 obtains the reference data from the distributed ledger 5, using the received reference matter data.

### (Step S042)

The data reference unit 11 transmits the obtained reference data to the data control unit 7.

### (Step S043)

The data control unit 7 transmits the received reference data to the reference data reception unit 15.

### *** Description of Effects of Embodiment 1 ***

As described above, according to the present embodiment, the data registration unit 10 verifies registration data, using the data verification unit 8 whose validity has been secured when the registration data is to be registered in the distributed ledger 5, and determines whether or not the registration data is to be registered in the distributed ledger 5 based on a verification result. Therefore, the validity of data registered in the distributed ledger 5 by the data registration unit 10 is secured.

Further, the data registration unit 10 registers in the distributed ledger 5, only registration data transmitted from the data control unit 7. Thus, according to the present embodiment, since it is possible to prevent the data registration unit 10 from being used improperly, the reliability of data registered by the data registration unit 10 in the distributed ledger 5 is increased.

Further, when referring data registered in the distributed ledger 5, the data control unit 7 verifies each of the data registration unit 10 included in the data registration reference unit 9 included in the data reference unit 11 and the data verification unit 8 used by the data registration unit 10. Therefore, it is secured that date referred to by the data reference unit 11 is data registered by the valid data registration unit 10.

Further, the data reference unit 11 obtains data from the distributed ledger 5 only when reference matter data has been transmitted from the data control unit 7. Therefore, it is secured that the data reference unit 11 refers to data in the distributed ledger 5 upon the verification of the data registration unit 10 and the data verification unit 8 has been performed by the data control unit 7. Further, the validity of the data obtained by the data reference unit 11 is secured.

### *** Other Configurations ***

### <Modification 1>

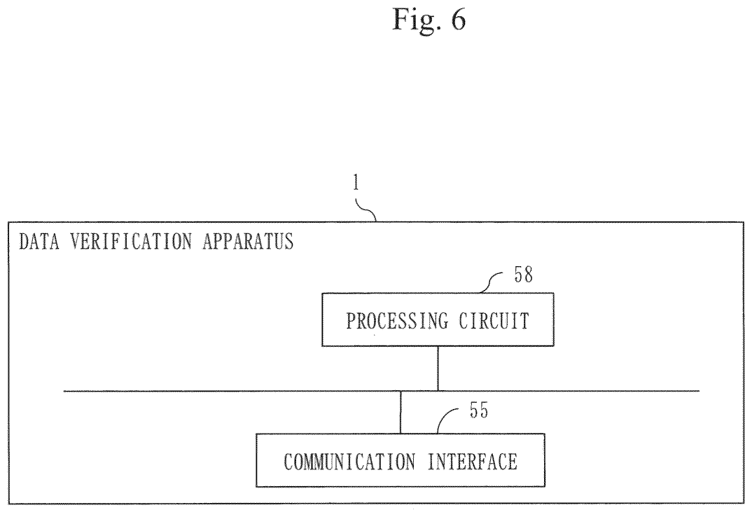

FIG. 6 is a hardware configuration example of the data verification apparatus 1 according to the present modification.

The data verification apparatus 1 includes a processing circuit 58 in place of the processor 51, the processor 51 and the memory 52, the processor 51 and the auxiliary storage device 53, or the processor 51, the memory 52, and the auxiliary storage device 53.

The processing circuit 58 is hardware that implements at least a part of each unit included in the data verification apparatus 1.

The processing circuit 58 may be dedicated hardware, or may be a processor that executes a program stored in the memory 52.

When the processing circuit 58 is the dedicated hardware, a specific example of the processing circuit 58 is a single circuit, a composite circuit, a programmed processor, a parallel-programmed processor, an Application Specific Integrated Circuit (ASIC), a Field Programmable Gate Array (FPGA), or a combination of thereof.

The data verification apparatus 1 may include a plurality of processing circuits as an alternative to the processing circuit 58. The plurality of processing circuits share the role of the processing circuit 58.

In the data verification apparatus 1, some functions may be implemented by the dedicated hardware, and the remaining functions may be implemented by software or firmware.

The processing circuit 58 is implemented by, as a specific example, hardware, software, firmware, or a combination of thereof.

The processor 51, the memory 52, the auxiliary storage device 53, and the processing circuit 58 are collectively referred to as “processing circuitry”. That is, the functions of the individual functional components of the data verification apparatus 1 are implemented by the processing circuitry.

Other apparatuses described in the present specification may also have the same configuration as that of the present modification.

### Embodiment 2

Differences from the embodiment described above will be mainly described below with reference to the drawings.

### *** Description of Configuration ***

In Embodiment 1, a BC infrastructure is used in which the SC generated by the SC automated generation unit 6 can be deployed to the BC server 2.

In the present embodiment, a BC infrastructure is used in which the SC generated by the SC automated generation unit 6 cannot be deployed to the BC server. In the present embodiment, even when an SC is deployed to the BC server 2 from outside the BC server 2, it is possible to confirm that the deployed SC is the SC generated by the SC automated generation unit 6.

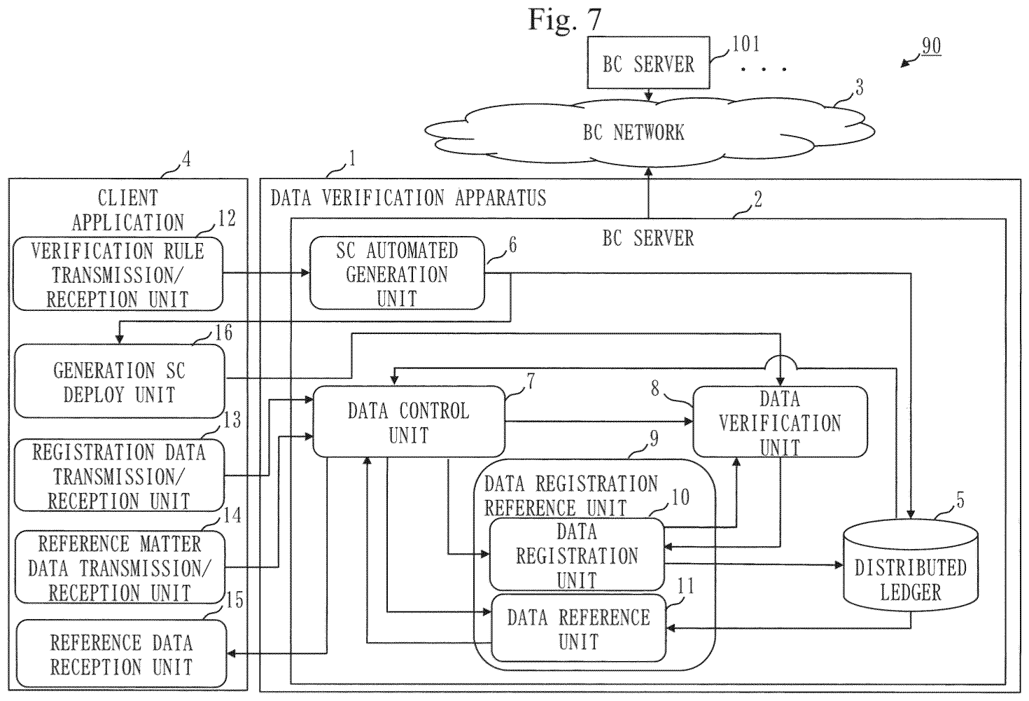

FIG. 7 illustrates a system configuration example of the BC system 90 according to the present embodiment.

The BC server 2 includes the SC automated generation unit 6, the data control unit 7, the data verification unit 8, the data registration reference unit 9, and the distributed ledger 5.

The SC automated generation unit 6 according to the present embodiment generates the data verification unit 8 based on data indicating the input verification rule, transmits to a generation SC deploy unit 16, data indicating the generated data verification unit 8, and registers in the distributed ledger 5, data corresponding to the data indicating the generated SC. The data corresponding to the data indicating the SC may be any data as long as it can be used to verify whether or not two SCs are consistent with each other, and is, as a specific example, data indicating a hash value of the data indicating the SC. A specific example of an algorithm for calculating the hash value is MD5, SHA-256, SHA-512, or RIPEMD-160. The data corresponding the data indicating the SC is hereinafter assumed to be the data indicating the hash value of the data indicating the SC.

The distributed ledger 5 according to the present embodiment records data registered by the SC automated generation unit 6, in addition to data registered in the distributed ledger 5 according to Embodiment 1.

The client application 4 according to the present embodiment includes the generation SC deploy unit 16 in addition to the components included in the client application 4 according to Embodiment 1.

The generation SC deploy unit 16 receives from the SC automated generation unit 6, data indicating the data verification unit 8, and deploys to the BC server 2, the data verification unit 8 corresponding to the received data. That is, the generation SC deploy unit 16 receives from the BC server 2, data indicating the program corresponding to the data verification process, and deploys to a server, a smart contract corresponding to the received data.

The BC network 3 is the same as that of Embodiment 1.

As described above, the configuration of the BC system 90 may be a configuration that does not include the client application 4.

A hardware configuration example of the BC system 90 according to Embodiment 2 is the same as the hardware configuration example of the BC system 90 according to Embodiment 1.

### *** Description of Operation ***

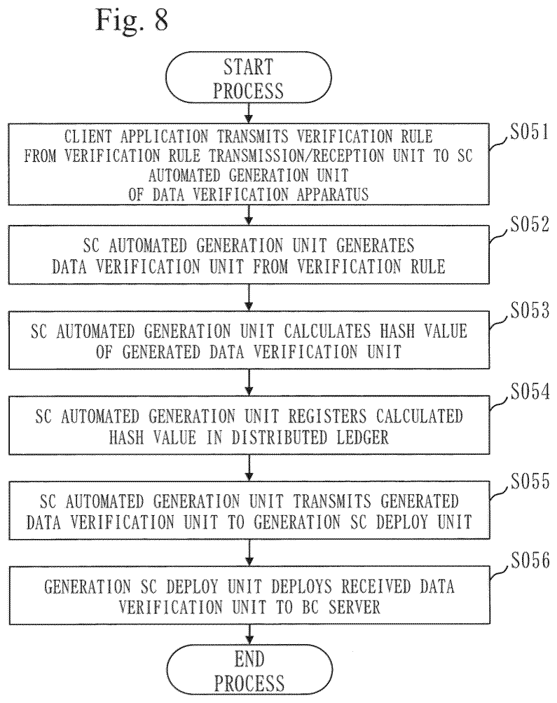

FIG. 8 is a flowchart illustrating an example of the deploy process. The deploy process will be described with reference to FIG. 8.

### (Step S051)

The present step is the same as step S001.

### (Step S052)

The present step is the same as step S002.

### (Step S053)

The SC automated generation unit 6 calculates a hash value of data indicating the generated data verification unit 8.

### (Step S054)

The SC automated generation unit 6 registers the calculated hash value in the distributed ledger 5.

### (Step S055)

The SC automated generation unit 6 transmits to the generation SC deploy unit 16, the data indicating the generated data verification unit 8.

### (Step S056)

The generation SC deploy unit 16 deploys to the BC server 2, the data verification unit 8 corresponding to the received data.

Through the above deploy process, the data verification unit 8 is usable in a BC server connected to the BC network 3. The data verification unit 8 may be usable only in some of BC servers among the BC servers connected to the BC network 3.

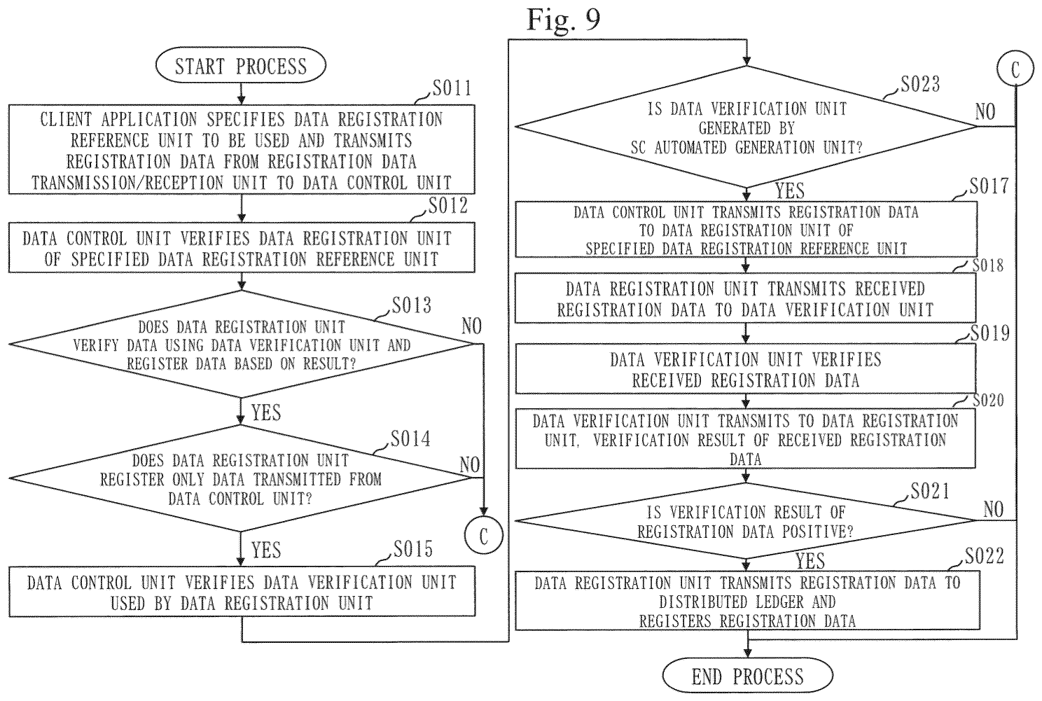

FIG. 9 is a flowchart illustrating an example of the data registration process. The data registration process will be described with reference to FIG. 9. Steps S011 to S015 and steps S017 to S022 are the same as those in Embodiment 1.

### (Step S023)

The data control unit 7 checks whether or not the data verification unit 8 is the authenticity data verification unit. The authenticity data verification unit according to the present embodiment is a data verification unit generated by the SC automated generation unit 6, and deployed by the generation SC deploy unit 16. Specifically, when a hash value registered in the distributed ledger 5 when the SC automated generation unit 6 has generated the data verification unit 8, and a hash value of data indicating the data verification unit 8 to be verified are consistent with each other, the data control unit 7 determines that the data verification unit 8 is the authenticity data verification unit.

When the data verification unit 8 is the authenticity data verification unit, the data verification apparatus 1 transitions to step S017. Otherwise, the data verification apparatus 1 skips all of processes onwards and ends the data registration process.

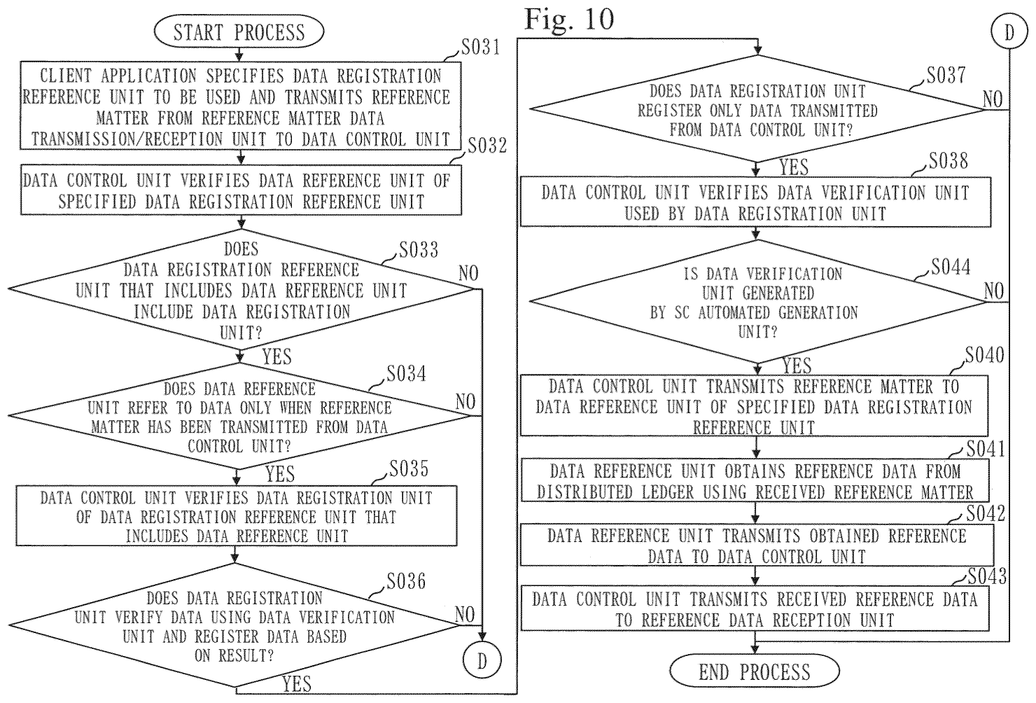

FIG. 10 is a flowchart illustrating an example of the data reference process. The data reference process will be described with reference to FIG. 10. Steps S031 to S038 and steps S040 to S043 are the same as those in Embodiment 1.

### (Step S044)

The present step is the same as step S023.

When the data verification unit 8 is the authenticity data verification unit, the data verification apparatus 1 transitions to step S040. Otherwise, the data verification apparatus 1 skips all of processes onwards and ends the data reference process.

### *** Description of Effects of Embodiment 2 ***

As described above, according to the present embodiment, the SC automated generation unit 6 registers in the distributed ledger 5, data corresponding to data indicating the generated data verification unit 8. Therefore, when the data verification unit 8 is deployed to the BC server 2 by other than the SC automated generation unit 6, it is possible to verify whether or not the data verification unit 8 is an SC generated by the SC automated generation unit 6, by using a hash value registered in the distributed ledger 5. Thus, according to the present embodiment, even when a BC infrastructure is used in which the SC generated by the SC automated generation unit 6 cannot be deployed to the BC server 2, the same effect as the effect in Embodiment 1 can be obtained.

### Embodiment 3

Differences from the embodiments described above will be mainly described below with reference to the drawings.

### *** Description of Configuration ***

In Embodiments 1 and 2, the data registration unit 10 and the data reference unit 11 belong to the data registration reference unit 9.

In the present embodiment, each of the data registration unit 10 and the data reference unit 11 is independent. In the present embodiment, even when each of the data registration unit 10 and the data reference unit 11 is independent, it is possible to confirm that data referred to by the data reference unit 11 is data registered by the valid data registration unit 10.

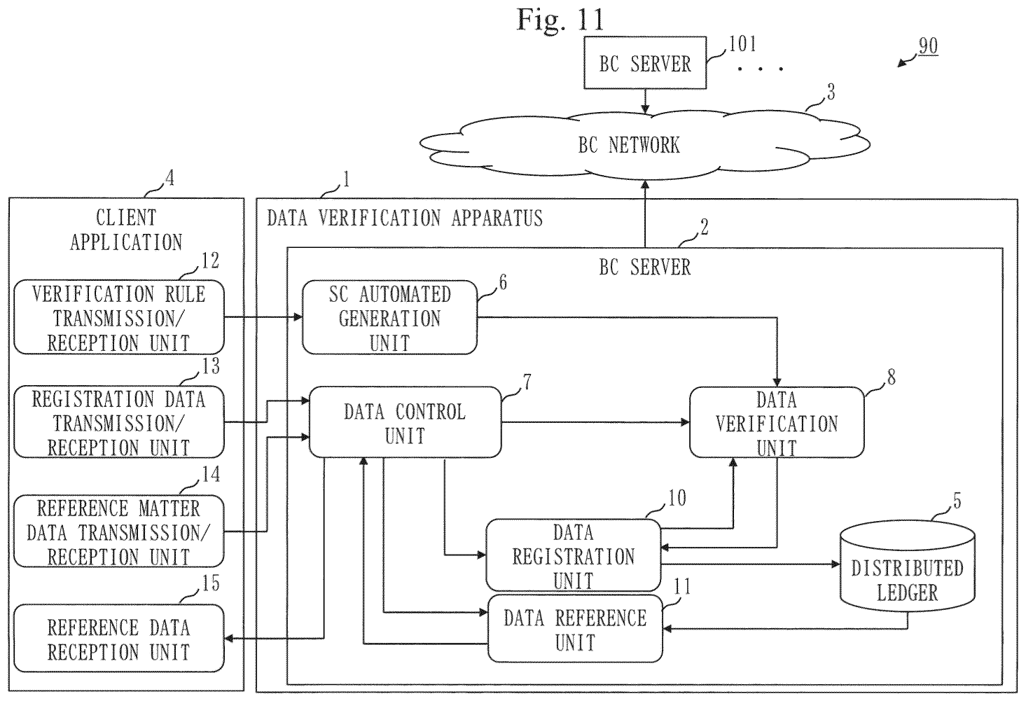

FIG. 11 illustrates a system configuration example of the BC system 90 according to the Embodiment 3.

The BC server 2 includes the SC automated generation unit 6, the data control unit 7, the data verification unit 8, the data registration unit 10, the data reference unit 11, and the distributed ledger 5.

A function of the data control unit 7 is basically the same as the function of the data control unit 7 described above. The data control unit 7 does not consider that the data registration unit 10 and the data reference unit 11 are included in the same data registration reference unit 9.

Each of the client application 4 and the BC network 3 is the same as that in Embodiment 1.

FIG. 11 illustrates a configuration in which the data registration unit 10 and the data reference unit 11 are made independent in the data verification apparatus 1 according to Embodiment 1. However, the configuration of the data verification apparatus 1 according to the present embodiment may be a configuration in which the data registration unit 10 and the data reference unit 11 are made independent in the data verification apparatus 1 according to Embodiment 2.

The configuration of the data verification apparatus 1 is hereinafter assumed to be the configuration illustrated in FIG. 11.

A hardware configuration example according to Embodiment 3 is the same as the hardware configuration example according to the embodiments described above.

### *** Description of Operation ***

The deploy process according to the present embodiment is the same as the deploy process according to the embodiments described above.

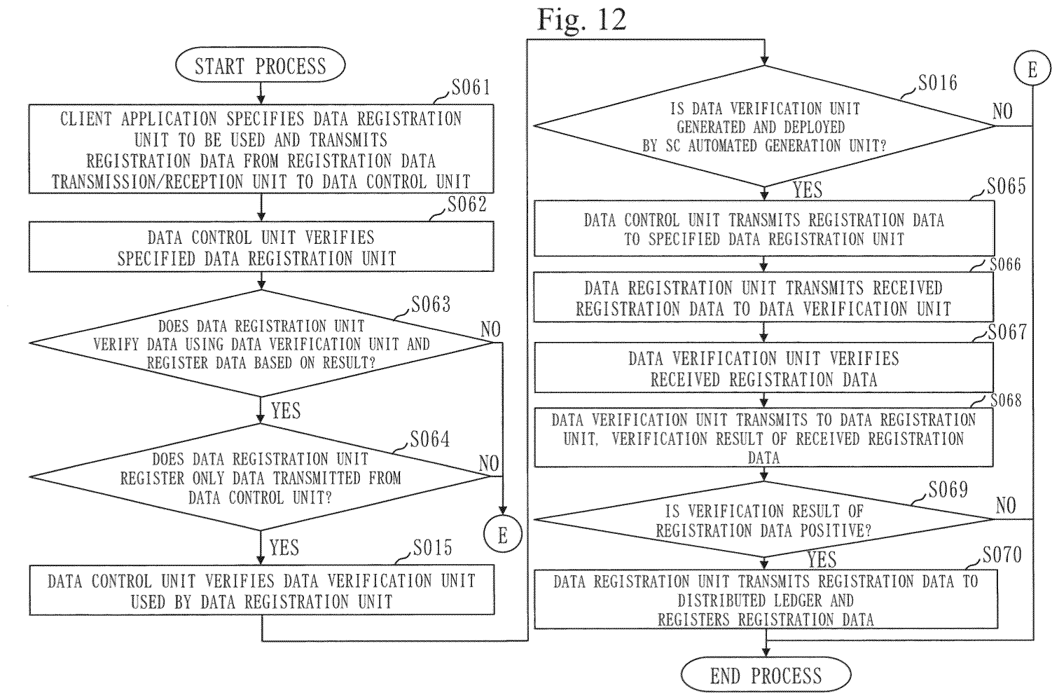

FIG. 12 is a flowchart illustrating an example of the data registration process. The data registration process will be described with reference to FIG. 12. Steps S015 to S016 are the same as those in Embodiment 1.

### (Step S061)

The registration data transmission/reception unit 13 specifies the data registration unit 10 to be used, and transmits to the data control unit 7 corresponding to the specified data registration unit 10, the registration data input by the user.

### (Step S062)

The data control unit 7 verifies the specified data registration unit 10. In steps S063 and S064, matters verified by the data control unit 7 will be described.

### (Step S063)

The present step is the same as step S013.

When the data registration unit 10 executes the verification registration process, the data verification apparatus 1 transitions to step S064. Otherwise, the data verification apparatus 1 skips all of processes onwards and ends the data registration process.

### (Step S064)

The present step is the same as step S014.

### (Step S065)

The data control unit 7 transmits the registration data to the specified data registration unit 10.

### (Step S066)

The present step is the same as step S018.

### (Step S067)

The present step is the same as step S019.

### (Step S068)

The present step is the same as step S020.

### (Step S069)

The present step is the same as step S021.

When the verification result indicated in the received verification result data is positive, the data verification apparatus 1 transitions to step S070. Otherwise, the data verification apparatus 1 skips all of processes onwards and ends the data registration process.

### (Step S070)

The present step is the same as step S022.

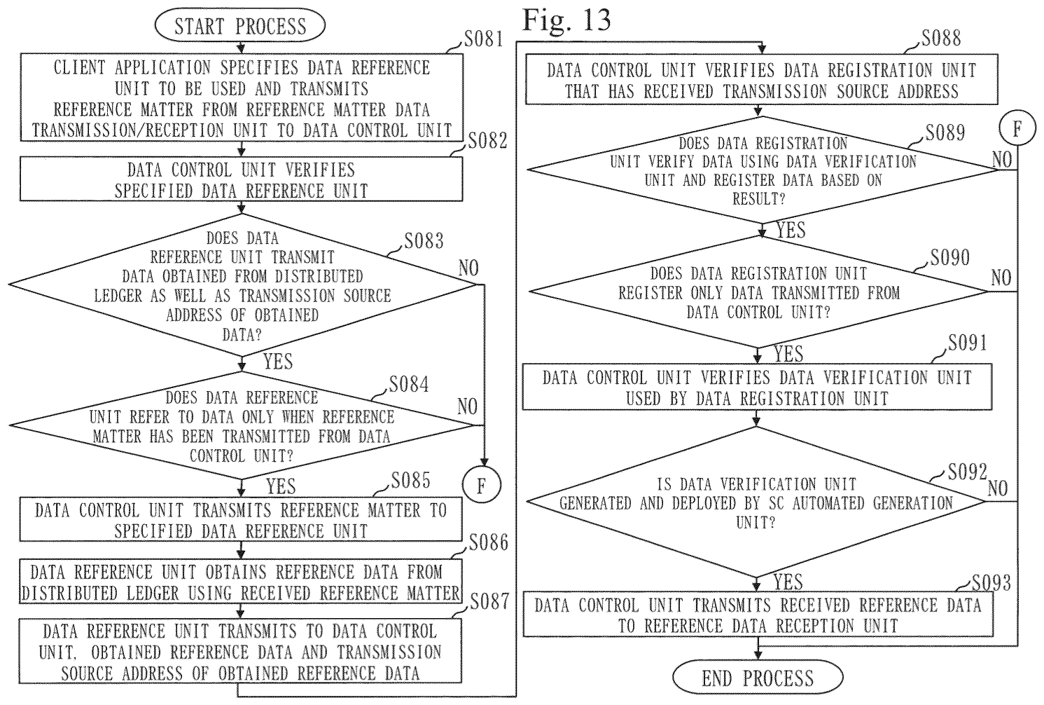

FIG. 13 is a flowchart illustrating an example of the data reference process. The data reference process will be described with reference to FIG. 13.

### (Step S081)

The reference matter data transmission/reception unit 14 specifies the data reference unit 11 to be used, and transmits to the data control unit 7 corresponding to the specified data reference unit 11, the reference matter data input by the user.

### (Step S082)

The data control unit 7 verifies the specified data reference unit 11. Matters verified by the data control unit 7 will be described in steps S083 and S084.

### (Step S083)

The data control unit 7 checks whether or not the data reference unit 11 executes an address transmission process. The address transmission process is a process to transmit to the data control unit 7, data obtained from the distributed ledger 5 as well as data indicating a transmission source address of the obtained data. The data indicating the transmission source address may be data indicating the transmission source address itself, or may be data that has been converted to data indicating the transmission source address itself, such as a hash value of the data indicating the transmission source address or data obtained by encrypting the data indicating the transmission source address. Specifically, the data control unit 7 checks whether or not each of the following two points is satisfied regarding a configuration of a program that implements the data reference unit 11. When all of the two points are satisfied, the data control unit 7 determines that the data reference unit 11 executes the address transmission process.

The first point is that a configuration of the data reference unit 11 is a configuration in which when obtaining data from the distributed ledger 5, the data reference unit 11 obtains data indicating the transmission source address of the obtained data.

The second point is that the configuration of the data reference unit 11 is a configuration in which the data reference unit 11 transmits to the data control unit 7, the obtained data as well as the data indicating the transmission source address of the obtained data.

When the data reference unit 11 executes the address transmission process, the data verification apparatus 1 transitions to step S084. Otherwise, the data verification apparatus 1 skips all of processes onwards and ends the data reference process.

### (Step S084)

The present step is the same as step S034.

When the data reference unit 11 executes the limited reference process, the data verification apparatus 1 transitions to step S085. Otherwise, the data verification apparatus 1 skips all of processes onwards and ends the data reference process.

### (Step S085)

The data control unit 7 transmits the reference matter data to the specified data reference unit 11.

### (Step S086)

The present step is the same as step S041.

### (Step S087)

The data reference unit 11 transmits to the data control unit 7, the data indicating the transmission source address of the obtained reference data.

### (Step S088)

The data control unit 7 verifies the data registration unit 10 corresponding to the received data. Here, as a specific example, when an address of data indicating the data registration unit 10 and an address indicated in the received data are consistent with each other, or when a hash value of the address of the data indicating the data registration unit 10 and a hash value indicated in the received data are consistent with each other, the data registration unit 10 corresponds to the received data. Matters verified by the data control unit 7 will be described in steps S089 and S090.

### (Step S089)

The present step is the same as step S013.

When the data registration unit 10 executes the verification registration process, the data verification apparatus 1 transitions to step S090. Otherwise, the data verification apparatus 1 skips all of processes onwards and ends the data reference process. Even when there is no data registration unit 10 corresponding to the received data, the data verification apparatus 1 skips all of processes onwards and ends the data reference process.

### (Step S090)

The present step is the same as step S014.

When the data registration unit 10 executes the limited registration process, the data verification apparatus 1 transitions to step S091. Otherwise, the data verification apparatus 1 skips all of processes onwards and ends the data reference process.

### (Step S091)

The present step is the same as step S015. Matters verified by the data control unit 7 will be described in step S092.

### (Step S092)

The present step is the same as step S016.

When the data verification unit 8 is the authenticity data verification unit, the data verification apparatus 1 transitions to step S093. Otherwise, the data verification apparatus 1 skips all of processes onwards and ends the data reference process.

### (Step S093)

The present step is the same as step S043.

### *** Description of Effects of Embodiment 3 ***

As described above, according to the present embodiment, the data control unit 7 can receive data obtained by the data reference unit 11 as well as data indicating a transmission source address of the obtained data, specify based on the received data, the data registration unit 10 that has registered reference data, and verify the specified data registration unit 10. Therefore, it is secured that the reference data is valid data registered by the valid data registration unit 10. Thus, according to the present embodiment, even when each of the data registration unit 10 and the data reference unit 11 is independent, the same effect as the effect in Embodiment 1 can be obtained at a time of data reference.

### Embodiment 4

Differences from the embodiments described above will be mainly described below with reference to the drawings.

### *** Description of Operation ***

In Embodiments 1, 2, and 3, each of the data registration unit 10 and the data reference unit 11 is sequentially verified at a time of data registration or data reference.

In the present embodiment, the verification result data indicating a result of verifying each of the data registration unit 10 and the data reference unit 11 is registered in the distributed ledger 5, and the verification result data registered in the distributed ledger 5 is appropriately used at times of the next and following verification execution.

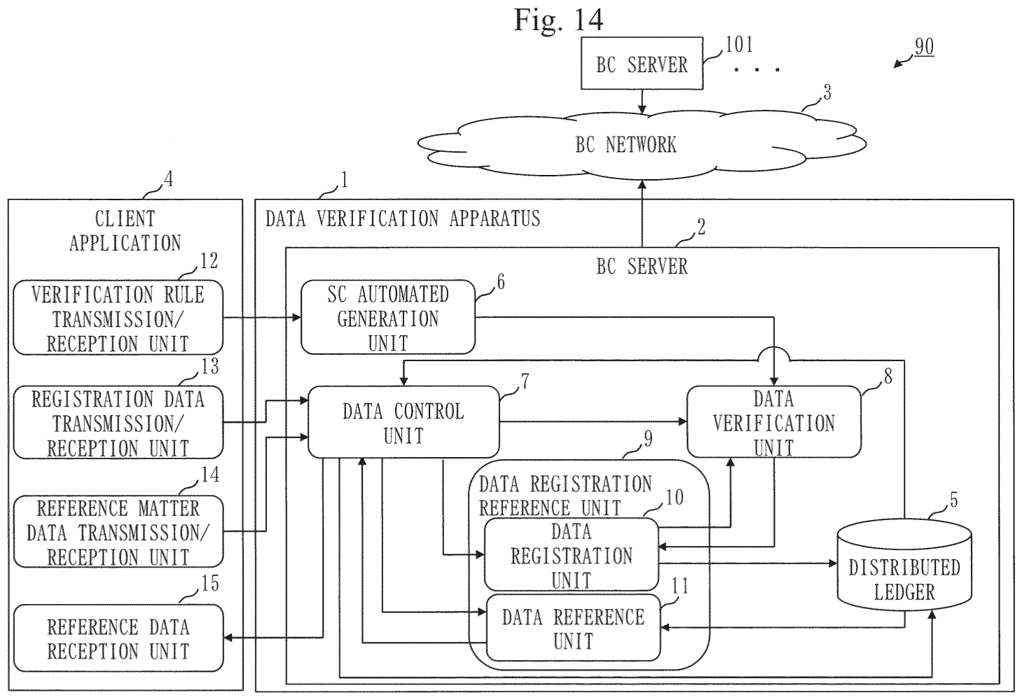

FIG. 14 illustrates a system configuration example of the BC system according to the present embodiment.

The BC server 2 includes the SC automated generation unit 6, the data control unit 7, the data verification unit 8, the data registration reference unit 9, and the distributed ledger 5.

The data control unit 7 has in addition to the function described above, a function to verify each of the data registration unit 10, the data reference unit 11, and the data verification unit 8, and to register in the distributed ledger 5, the verification result data indicating a verified result. Further, the data control unit 7 has a function to refer to the verification result data registered in the distributed ledger 5 to verify each of the data registration unit 10, the data reference unit 11, and the data verification unit 8. That is, the data control unit 7 registers in the distributed ledger 5, first verification result data and second verification result data. The first verification result data indicates a result of verifying a program corresponding to the verification registration process. The second verification result data indicates a result of verifying a program corresponding to the data reference process. The program corresponding to the data reference process is a program that implements the data reference unit 11. Further, the data control unit 7 refers to the first verification result data registered in the distributed ledger 5 to verify the program corresponding to the verification registration process, and refers to the second verification result data registered in the distributed ledger 5 to verify the program corresponding to the data reference process. The data control unit 7 may use any data when specifying each unit, but the data control unit 7 is hereinafter assumed to use a hash value when specifying each unit.

Each of the client application 4 and the BC network 3 is the same as that of Embodiment 1.

FIG. 14 illustrates a configuration in which the function to register in the distributed ledger, the verification result data corresponding to each of the data registration unit 10, the data reference unit 11, and the data verification unit 8, and the function to refer to the verification result data which is registered in the distributed ledger 5 and which corresponds to each of the data registration unit 10, the data reference unit 11, and the data verification unit 8, are added to the data verification apparatus 1 according to the Embodiment 1. The data verification apparatus 1 according to the present embodiment may have a configuration in which these functions are added to the data verification apparatus 1 according to any of Embodiments 2 and 3.

The configuration of the data verification apparatus 1 is hereinafter assumed to be the configuration illustrated in FIG. 14.

A hardware configuration example according to Embodiment 4 is the same as the hardware configuration example of the embodiments described above.

### *** Description of Operation ***

The deploy process according to the present embodiment is the same as the deploy process according to the embodiments described above.

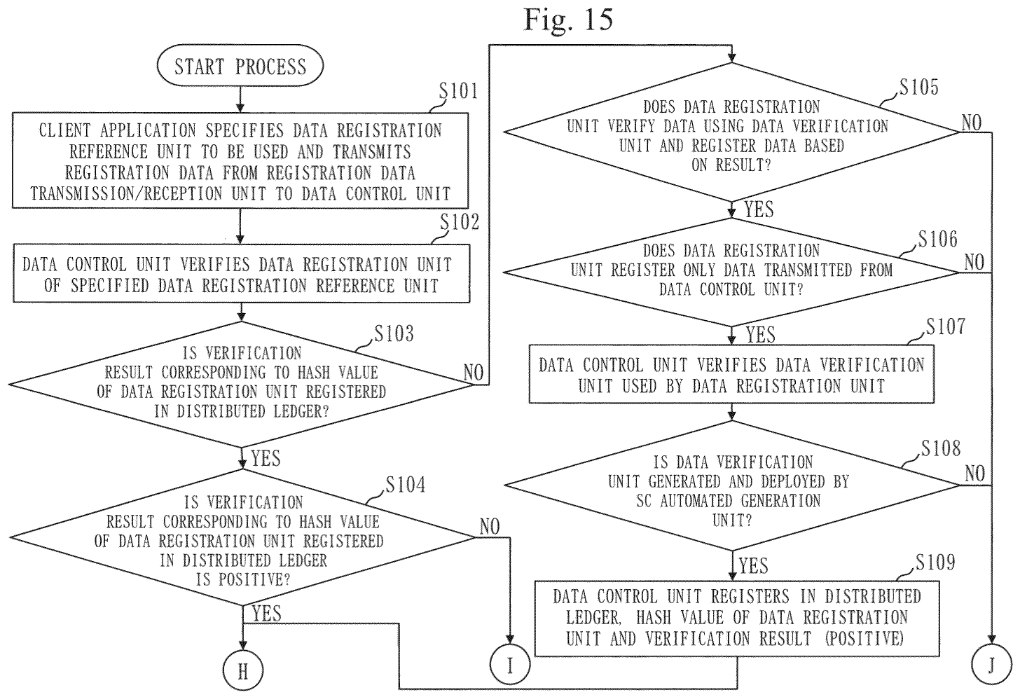

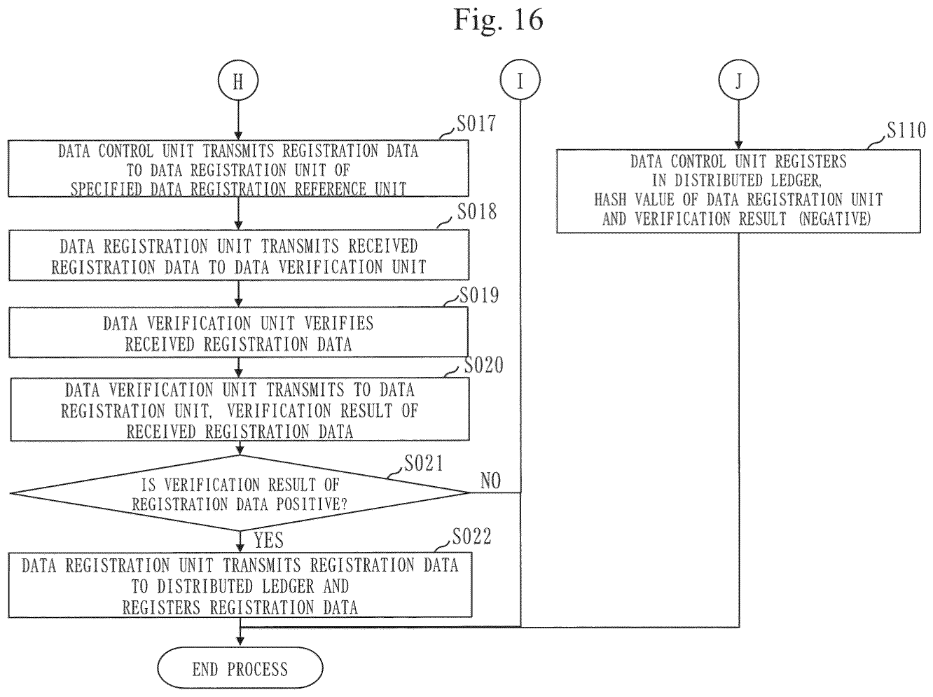

FIGS. 15 and 16 are flowcharts illustrating an example of the data registration process. The data registration process will be described with reference to FIGS. 15 and 16. Steps S017 to S022 are the same as those in Embodiment 1.

### (Step S101)

The present step is the same as step S011. In the following description of the present flowchart, the data registration unit 10 refers to the data registration unit 10 included in the data registration reference unit 9 specified in the present step.

### (Step S102)

The present step is the same as step S012. Matters verified by the data control unit 7 will be described in steps S103 and S104.

### (Step S103)

The data control unit 7 checks whether or not the verification result data corresponding to a hash value of data indicating the data registration unit 10 is registered in the distributed ledger 5. Specifically, the data control unit 7 checks whether or not each of the following two points is satisfied regarding data registered in the distributed ledger 5. When all of the two points are satisfied, the data control unit 7 determines that the verification result data corresponding to the hash value of the data indicating the data registration unit 10 is registered in the distributed ledger 5.

The first point is that the hash value of the data indicating the data registration unit 10 is registered in the distributed ledger 5.

The second point is that the verification result data corresponding to the hash value of the data indicating the data registration unit 10 is registered in the distributed ledger 5.

When the verification result data corresponding to the hash value of the data indicating the data registration unit 10 is registered in the distributed ledger 5, the data verification apparatus 1 transitions to step S104. Otherwise, the data verification apparatus 1 transitions to step S105.

### (Step S104)

When the verification result data corresponding to the hash value of the data indicating the data registration unit 10 is registered in the distributed ledger 5, the data control unit 7 checks whether a verification result indicated in the verification result data indicates positive or negative. The hash value of the data indicating the data registration unit 10 and the verification result data corresponding to the hash value are registered in the distributed ledger 5 in steps S109 and S110.

When the verification result indicated in the verification result data which is registered in the distributed ledger 5 and which corresponds to the hash value of the data indicating the data registration unit 10 indicates positive, the data verification apparatus 1 transitions to step S017. Otherwise, the data verification apparatus 1 skips all of processes onwards and ends the data registration process.

### (Step S105)

When the verification result data corresponding to the hash value of the data indicating the data registration unit 10 is not registered in the distributed ledger 5, the data control unit 7 checks by executing the process indicated in step S013, whether or not the data registration unit 10 executes the verification registration process.

When the data registration unit 10 executes the verification registration process, the data verification apparatus 1 transitions to step S106. Otherwise, the data verification apparatus 1 transitions to step S110.

### (Step S106)

When the data registration unit 10 executes the verification registration process, the data control unit 7 checks by executing the process indicated in step S014, whether or not the data registration unit 10 executes the limited registration process.

When the data registration unit 10 executes the limited registration process, the data verification apparatus 1 transitions to step S107. Otherwise, the data verification apparatus 1 transitions to step S110.

### (Step S107)

When the data registration unit 10 executes the limited registration process, the data control unit 7 verifies the data verification unit 8 used by the data registration unit 10. Matters verified by the data control unit 7 will be described in step S108.

### (Step S108)

The present step is the same as step S016.

When the data verification unit 8 is the authenticity data verification unit, the data verification apparatus 1 transitions to step S109. Otherwise, the data verification apparatus 1 transitions to step S110.

### (Step S109)

When the data verification unit 8 is the authenticity data verification unit, the data control unit 7 registers in the distributed ledger 5, the hash value of the data indicating the data registration unit 10 made corresponded to the verification result data indicating that the verification result of the data registration unit 10 is positive.

### (Step S110)

When the data registration unit 10 does not execute the verification registration process, when the data registration unit 10 does not execute the limited registration process, or when the data verification unit 8 is not the authenticity data verification unit, the data control unit 7 registers in the distributed ledger 5, the hash value of the data indicating the data registration unit 10 made corresponded to the verification result data indicating that the verification result of the data registration unit 10 is negative.

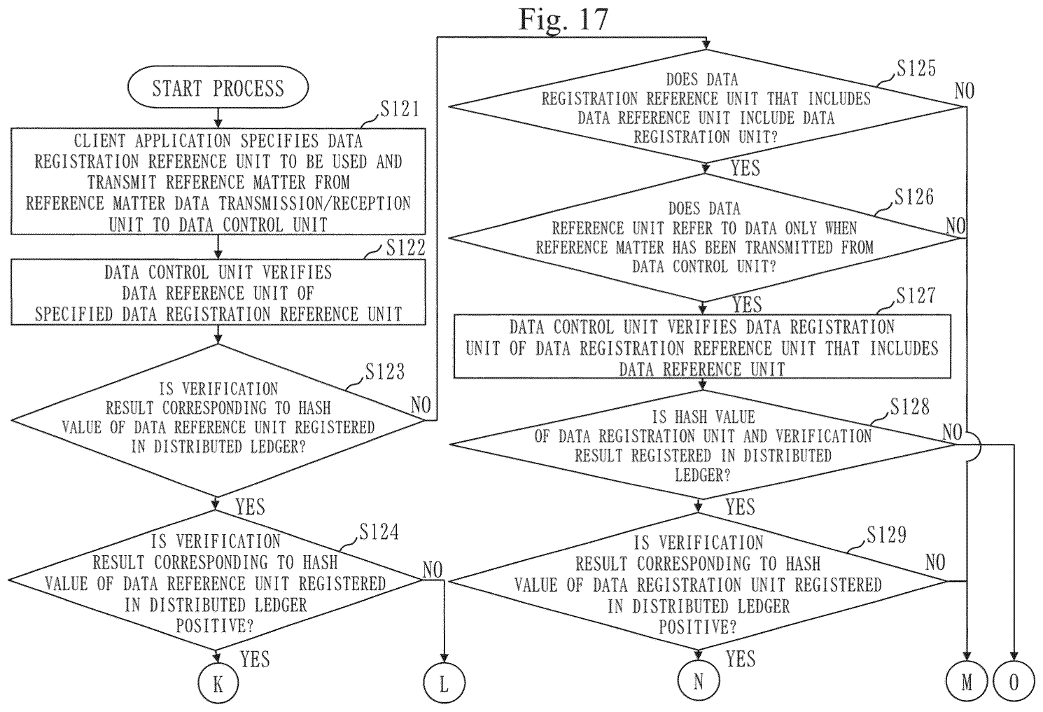

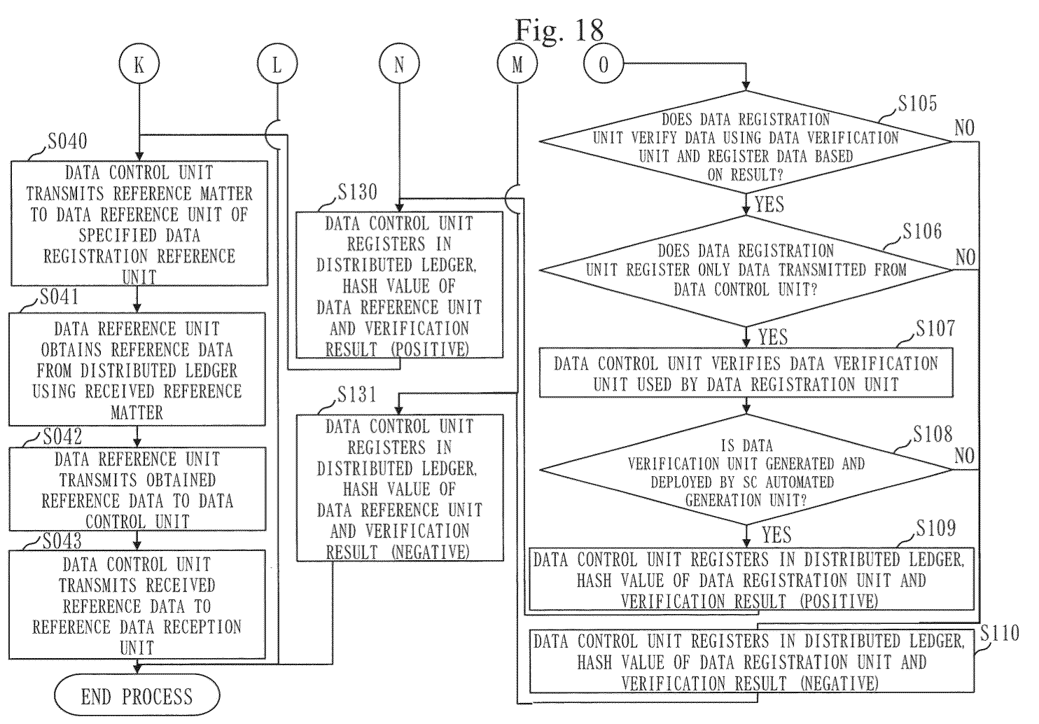

FIGS. 17 and 18 are flowcharts illustrating an example of the data reference process. The data reference process will be described with reference to FIGS. 17 and 18. Steps S040 to S043 are the same as those in Embodiment 1.

### (Step S121)

The present step is the same as step S031. In the following description of the present flowchart, the data reference unit 11 refers to the data reference unit 11 included in the data registration reference unit 9 specified in the present step.

### (Step S122)

The present step is the same as step S032. Matters verified by the data control unit 7 will be described in steps S123 to S126.

### (Step S123)

The data control unit 7 checks whether or not the verification result data corresponding to a hash value of data indicating the data reference unit 11 is registered in the distributed ledger 5. The data control unit 7 checks whether or not each of the following two points is satisfied regarding data registered in the distributed ledger 5. When all of the two points are satisfied, it is determined that the verification result data corresponding to the hash value of the data indicating the data reference unit 11 is registered in the distributed ledger 5.

The first point is that the hash value of the data indicating the data reference unit 11 is registered in the distributed ledger 5.

The second point is that the verification result data corresponding to the hash value of the data indicating the data reference unit 11 is registered in the distributed ledger 5.

When the verification result data corresponding to the hash value of the data indicating the data reference unit 11 is registered in the distributed ledger 5, the data verification apparatus 1 transitions to step S124. Otherwise, the data verification apparatus 1 transitions to step S125.

### (Step S124)

When the verification result data corresponding to the hash value of the data indicating the data reference unit 11 is registered in the distributed ledger 5, the data control unit 7 checks whether a verification result indicated in the verification result data indicates positive or negative. The hash value of the data indicating the data reference unit 11 and the verification result data corresponding to the hash value are registered in the distributed ledger 5 in steps S130 and S131.

When the verification result indicated in the verification result data which is registered in the distributed ledger 5 and which corresponds to the hash value of the data indicating the data reference unit 11 indicates positive, the data verification apparatus 1 transitions to step S040. Otherwise, the data verification apparatus 1 skips all of processes onwards and ends the data reference process.

### (Step S125)

When the verification result data corresponding to the hash value of the data indicating the data reference unit 11 is not registered in the distributed ledger 5, the data control unit 7 checks by executing the process indicated in step S033, whether or not the data registration reference unit 9 that includes the data reference unit 11 includes the data registration unit 10.

When the data registration reference unit 9 that includes the data reference unit 11 includes the data registration unit 10, the data verification apparatus 1 transitions to step S126. Otherwise, the data verification apparatus 1 transitions to step S131.

### (Step S126)

When the data registration reference unit 9 that includes the data reference unit 11 includes the data registration unit 10, the data control unit 7 checks by executing the process indicated in step S034, whether or not the data reference unit 11 executes the limited reference process.

When the data reference unit 11 executes the limited reference process, the data verification apparatus 1 transitions to step S127. Otherwise, the data verification apparatus 1 transitions to step S131.

### (Step S127)

When the data reference unit 11 executes the limited reference process, the data control unit 7 verifies the data registration unit 10 included in the data registration reference unit 9 that includes the data reference unit 11. Matters verified by the data control unit 7 will be described in steps S128, S129, S105, and S106.

### (Step S128)

The present step is the same as step S103.

When the verification result data corresponding to the hash value of the data indicating the data registration unit 10 is registered in the distributed ledger 5, the data verification apparatus 1 transitions to step S129. Otherwise, the data verification apparatus 1 transitions to step S105.

### (Step S129)

The present step is the same as step S104. The hash value of the data indicating the data registration unit 10 and the verification result data corresponding to the hash value are registered in the distributed ledger 5 in steps S109 and S110.

When the verification result indicating the verification result data which is registered in the distributed ledger 5 and which corresponds to the hash value of the data indicating the data registration unit 10 indicates positive, the data verification apparatus 1 transitions to step S130. Otherwise, the data verification apparatus 1 transitions to step S131.

### (Step S130)

When the verification result indicated in the verification result data corresponding to the hash value of the data indicating the data registration unit 10 registered in the distributed ledger 5 indicates positive, the data control unit 7 registers in the distributed ledger 5, the hash value of the data indicating the data reference unit 11 made corresponded to the verification result data indicating that the verification result is positive.

When the verification result data corresponding to the hash value of the data indicating the data registration unit 10 is not registered in the distributed ledger 5, the processes indicated in steps S105 to S108 and step S109 or S110 are executed as described in the data registration process. Further, after executing the process indicated in step S109, the data control unit 7 registers in the distributed ledger 5, the hash value of the data indicating the data reference unit 11 made corresponded to the verification result data indicating that the verification result is positive.

### (Step S131)

After executing the process indicated in step S110, the data control unit 7 registers in the distributed ledger 5, the hash value of the data indicating the data reference unit 11 made corresponded to the verification result data indicating that the verification result is negative.

### *** Description of Effects of Embodiment 4 ***

As described above, according to the present embodiment, the data control unit 7 registers in the distributed ledger 5, verification result data at a time of verification execution. Here, the data control unit 7 can use the verification result data registered in the distributed ledger 5 at the time of verification execution. Thus, according to the present embodiment, the same effect as the effect in Embodiment 1 can be obtained, and furthermore, a time required for verification of each unit can be shortened.

### Other Embodiments

Each of the above described embodiments can be freely combined, or any component of each of the embodiments can be modified. Alternatively, any component can be omitted in each of the embodiments.

Alternatively, the embodiments are not limited to those presented in Embodiments 1 to 4, and various modifications can be made as needed. The procedures described using the flowcharts or the like may be suitably modified.

### REFERENCE SIGNS LIST

1: data verification apparatus; 2, 101: BC server; 3: BC network; 4: client application; 5: distributed ledger; 6: SC automated generation unit; 7: data control unit; 8: data verification unit; 9: data registration reference unit; 10: data registration unit; 11: data reference unit; 12: verification rule transmission/reception unit; 13: registration data transmission/reception unit; 14: reference matter data transmission/reception unit; 15: reference data reception unit; 16: generation SC deploy unit; 51: processor; 52: memory; 53: auxiliary storage device; 54: communication interface; 58: processing circuit; 90: BC system.

1. A data verification apparatus that verifies electronic data to be registered in a distributed ledger stored in a server that constitutes a blockchain, the data verification apparatus comprising:
processing circuitry:
to execute a data verification process to determine whether or not registration data which is electronic data required to be registered in the distributed ledger complies with a verification rule which is a rule for verifying the electronic data to be registered in the distributed ledger;
to determine whether or not a program corresponding to the data verification process has been generated in the blockchain; and
to execute a verification registration process when it is determined that the program corresponding to the data verification process has been generated in the blockchain, wherein
the verification registration process is a process to register the registration data in the distributed ledger when it is determined through the data verification process that the registration data complies with the verification rule.

2. The data verification apparatus according to claim 1, wherein
when it is determined that the program corresponding to the data verification process has been generated in the blockchain, and when it is determined that reference data which is electronic data registered in the distributed ledger and is electronic data corresponding to reference matter data indicating an instruction to refer to the electronic data registered in the distributed ledger, has been registered in the distributed ledger through the verification registration process, the processing circuitry executes based on the reference matter data, a data reference process which is a process to refer to the electronic data registered in the distributed ledger.

3. The data verification apparatus according to claim 2, wherein
the processing circuitry executes a registration instruction process to instruct electronic data to be registered in the distributed ledger, and when only electronic data indicated through the registration instruction process is registered in the distributed ledger and when electronic data is registered in the distributed ledger through the verification registration process, determines that the reference data has been registered in the distributed ledger through the verification registration process.

4. The data verification apparatus according to claim 2, wherein
the processing circuitry executes a registration instruction process to instruct electronic data to be registered in the distributed ledger, and when only electronic data indicated through the registration instruction process is registered in the distributed ledger, when electronic data is registered in the distributed ledger through the verification registration process, and when a transmission source address of the reference data is an address corresponding to a program corresponding to the verification registration process, determines that the reference data has been registered in the distributed ledger through the verification registration process.

5. The data verification apparatus according to claim 1, wherein
the processing circuitry registers in the distributed ledger, first verification result data indicating a result of verifying a program corresponding to the verification registration process, and refers to the first verification result data registered in the distributed ledger to verify the program corresponding to the verification registration process.

6. The data verification apparatus according to claim 2, wherein
the processing circuitry registers in the distributed ledger, second verification result data indicating a result of verifying a program corresponding to the data reference process, and refers to the second verification result data registered in the distributed ledger to verify the program corresponding to the data reference process.

7. A blockchain system comprising:
the data verification apparatus according to claim 1; and
a client application that communicates with a server that constitutes a blockchain, the client application comprising
processing circuitry to receive from the server, data indicating a program corresponding to a data verification process to determine whether or not registration data which is electronic data required to be registered in a distributed ledger stored in the server complies with a verification rule which is a rule for verifying the electronic data to be registered in the distributed ledger, and to deploy to the server, a smart contract corresponding to the received data.

8. A blockchain system comprising:
the data verification apparatus according to claim 2; and
a client application that communicates with a server that constitutes a blockchain, the client application comprising
processing circuitry to receive from the server, data indicating a program corresponding to a data verification process to determine whether or not registration data which is electronic data required to be registered in a distributed ledger stored in the server complies with a verification rule which is a rule for verifying the electronic data to be registered in the distributed ledger, and to deploy to the server, a smart contract corresponding to the received data.

9. A blockchain system comprising:
the data verification apparatus according to claim 3; and
a client application that communicates with a server that constitutes a blockchain, the client application comprising
processing circuitry to receive from the server, data indicating a program corresponding to a data verification process to determine whether or not registration data which is electronic data required to be registered in a distributed ledger stored in the server complies with a verification rule which is a rule for verifying the electronic data to be registered in the distributed ledger, and to deploy to the server, a smart contract corresponding to the received data.

10. A blockchain system comprising:
the data verification apparatus according to claim 4; and
a client application that communicates with a server that constitutes a blockchain, the client application comprising
processing circuitry to receive from the server, data indicating a program corresponding to a data verification process to determine whether or not registration data which is electronic data required to be registered in a distributed ledger stored in the server complies with a verification rule which is a rule for verifying the electronic data to be registered in the distributed ledger, and to deploy to the server, a smart contract corresponding to the received data.

11. A blockchain system comprising:
the data verification apparatus according to claim 5; and
a client application that communicates with a server that constitutes a blockchain, the client application comprising
processing circuitry to receive from the server, data indicating a program corresponding to a data verification process to determine whether or not registration data which is electronic data required to be registered in a distributed ledger stored in the server complies with a verification rule which is a rule for verifying the electronic data to be registered in the distributed ledger, and to deploy to the server, a smart contract corresponding to the received data.

12. A blockchain system comprising:
the data verification apparatus according to claim 6; and
a client application that communicates with a server that constitutes a blockchain, the client application comprising
processing circuitry to receive from the server, data indicating a program corresponding to a data verification process to determine whether or not registration data which is electronic data required to be registered in a distributed ledger stored in the server complies with a verification rule which is a rule for verifying the electronic data to be registered in the distributed ledger, and to deploy to the server, a smart contract corresponding to the received data.

13. A data verification method to be executed by a computer which is a data verification apparatus that verifies electronic data to be registered in a distributed ledger stored in a server that constitutes a blockchain, the data verification method comprising:
executing a data verification process to determine whether or not registration data which is electronic data required to be registered in the distributed ledger complies with a verification rule which is a rule for verifying the electronic data to be registered in the distributed ledger;
executing a data control process to determine whether or not a program corresponding to the data verification process has been generated in the blockchain, and
executing a verification registration process when it is determined that the program corresponding to the data verification process has been generated in the blockchain, wherein
the verification registration process is a process to register the registration data in the distributed ledger when it is determined through the data verification process that the registration data complies with the verification rule.

14. A non-transitory computer readable medium storing a data verification program that is executed by a computer which is a data verification apparatus that verifies electronic data to be registered in a distributed ledger stored in a server that constitutes a blockchain, the data verification program for causing the data verification apparatus to execute:
a data verification process to determine whether or not registration data which is electronic data required to be registered in the distributed ledger complies with a verification rule which is a rule for verifying the electronic data to be registered in the distributed ledger;
a data control process to determine whether or not a program corresponding to the data verification process has been generated in the blockchain,
a verification registration process when it is determined that the program corresponding to the data verification process has been generated in the blockchain, wherein
the verification registration process is a process to register the registration data in the distributed ledger when it is determined through the data verification process that the registration data complies with the verification rule.
